(19) United States
(12) Patent Application Publication
(10) Pub. No.: US 2006/0208945 A1
(43) Pub. Date: Sep. 21, 2006

(54) Space / time / polarization adaptive antenna for ESM / ELINT receivers

(76) Inventor: James Kolanek, Goleta, CA (US)

Correspondence Address: BOSE MCKINNEY & EVANS LLP, 135 N PENNSYLVANIA ST, SUITE 2700, INDIANAPOLIS, IN, 46204, US

(21) Appl. No.: 11/363,614

(22) Filed: Feb. 28, 2006

Related U.S. Application Data
(60) Provisional application No. 60/657,048, filed on Feb. 28, 2005.

(51) Int. Cl. H01Q 3/00; G01S 3/16

(52) U.S. Cl. 342/377; 342/383

(57) ABSTRACT

An adaptive array for detecting a signal of interest (SOI) that includes antenna elements, digital Finite Impulse Response (FIR) filters having programmable filter weights, a digital beamformer having programmable array weights and an adaptive control unit. Each antenna output signal is processed by an FIR filter to produce a filtered element signal. The filtered element signals are combined by the beamformer to produce an adaptive array output. The adaptive control unit adjusts the filter and array weights to maximize the adaptive array response to the SOI while minimizing the response to interfering signals. The adaptive control unit can use the frequency, look angle or polarization of the SOI, to constrain the spatial gain or polarization in the direction of the SOI, or to form a pass band at the SOI frequency. The adaptive control unit can equalize the beamformer frequency response to compensate for dispersion introduced by diverse antenna locations.

This application claims the benefit of U.S. Provisional Patent Application Ser. No. 60/657,048, filed Feb. 28, 2005, titled CMV SPACE-TIME POLARIZATION ADAPTIVE ARRAY, the disclosure of which is expressly incorporated by reference herein.

### TECHNICAL FIELD OF THE INVENTION

The present invention relates to methods and systems for signal detection. More specifically, the invention relates to methods and systems of using multiple antennas to form an adaptive array that can suppress in-band interfering signals while at the same time receiving one or more desired signals of interest.

### BACKGROUND OF THE INVENTION

Electronic support measure and electronic intelligence (ESM/ELINT) receivers typically are designed with wide instantaneous RF bandwidths to intercept pulse signals from multiple emitters over broad frequency regions with high probability of intercept (POI). Since most signals tend to have narrow pulse widths and the average combined pulse rates are low, a high probability of intercept is maintained due on the temporal isolation of individual pulses. However, wideband designs are susceptible to blockage from high level, high duty cycle or continuous waveform in-band interference (which is increasingly likely due to the wide bandwidth) that can completely inhibit the detection of the desired pulse signals. Such interference can be due, for example, to nearby high power jammers and data links.

ESM/ELINT receivers have sometimes employed narrow band tuners to improve sensitivity and to reject out of band interference, but this is done at the expense of increasing the time to intercept (TTI) when searching for emitters. Tunable band reject filters have also been employed to remove high duty cycle interference but this can block detection of desired signals that are near or within the bandwidth of the reject filter. Channelized receivers have been introduced to mitigate the limitations of narrow band tuners but these still remain susceptible of channel blockage from high duty cycle interference.

### SUMMARY OF THE INVENTION

The adaptive interference canceller described in this invention is able to solve the above problems by employing three domains (spatial, spectral or time, and polarization) to suppress high duty interference while allowing the desired pulse signals to be detected and processed in the presence of high levels of in-band interference.

The adaptive interference canceller described in this invention is able to solve the above problems by employing three domains (spatial, spectral or time, and polarization) to suppress high duty interference while allowing the desired pulse signals to be detected and processed in the presence of high levels of in-band interference.

The present invention makes use of multiple antennas with possibly arbitrary locations and diverse polarization to form an adaptive array that can suppress in-band interfering signals (IS) while at the same time receiving one or more desired signals of interest (SOI). The antenna output signals are processed by first using adaptive Finite Impulse Response (FIR) filters following each of the antenna elements to form spectral nulls and/or to compensate for wideband dispersion effects. This is followed by an adaptive beamformer that combines all of the filtered element signals to form spatial and/or polarization nulls to suppress the IS while at the same time passing the SOI. The current adaptation processor makes use of a Constrained Minimum Variance (CMV) algorithm to allow one or more desired signals to pass while suppressing the unwanted interfering signals. Variations on the CMV algorithm or other algorithms known in the art can be used.

Additional features of the invention will become apparent to those skilled in the art upon consideration of the following detailed description, accompanying drawings, and appended claims.

### BRIEF DESCRIPTIONS OF THE DRAWINGS

FIGS. 1 shows a top-level block diagram of the antennas, FIR filters and array beam forming elements,

FIG. 2 shows the adapted spatial/polarization (SP) gain pattern for a SOI and two IS;

FIG. 3 shows the antenna coupling matrix and array beam former;

FIG. 4 shows the relationships between a selected reference point, the n-th antenna element, the antenna element gain pattern and various vector elements describing the relationships between the reference point, n-th antenna element and the direction to the m-th signal source;

FIG. 5 shows the top level block diagram for adaptive array signal processing elements and the adaptive control element;

FIG. 6 shows the two-element, dual-polarized antenna array used in the simulation;

FIG. 7 shows the adapted antenna pattern for case 1 using the SP-CMV method with one SOI and one IS;

FIG. 8 shows the adapted antenna pattern for case 1 using the STP-CMV method with one SOI and one IS;

FIG. 9 shows the beamformer output for the un-adapted beamformer for case 1 with one SOI and one IS;

FIG. 10 shows the beamformer output for the adapted SP-CMV beamformer for case 1 with one SOI and one IS;

FIG. 11 shows the beamformer output for the adapted STP-CMV beamformer for case 1 with one SOI and one IS;

FIG. 12 shows the adapted antenna pattern for case 2 using the SP-CMV method with one SOI and two IS;

FIG. 13 shows the adapted antenna pattern for case 2 using the STP-CMV method with one SOI and two IS;

FIG. 14 shows the beamformer output for the adapted SP-CMV beamformer for case 2 with one SOI and two IS;

FIG. 15 shows the beamformer output for the adapted STP-CMV beamformer for case 2 with one SOI and two IS;

FIG. 16 shows the adapted antenna pattern for case 3 using the SP-CMV method with one SOI and three IS;

FIG. 17 shows the adapted antenna pattern for case 3 using the STP-CMV method with one SOI and three IS;

FIG. 18 shows the beamformer output for the adapted SP-CMV beamformer for case 3 with one SOI and three IS; and

FIG. 19 shows the beamformer output for the adapted STP-CMV beamformer for case 3 with one SOI and three IS.

### DETAILED DESCRIPTION OF EXEMPLARY EMBODIMENTS

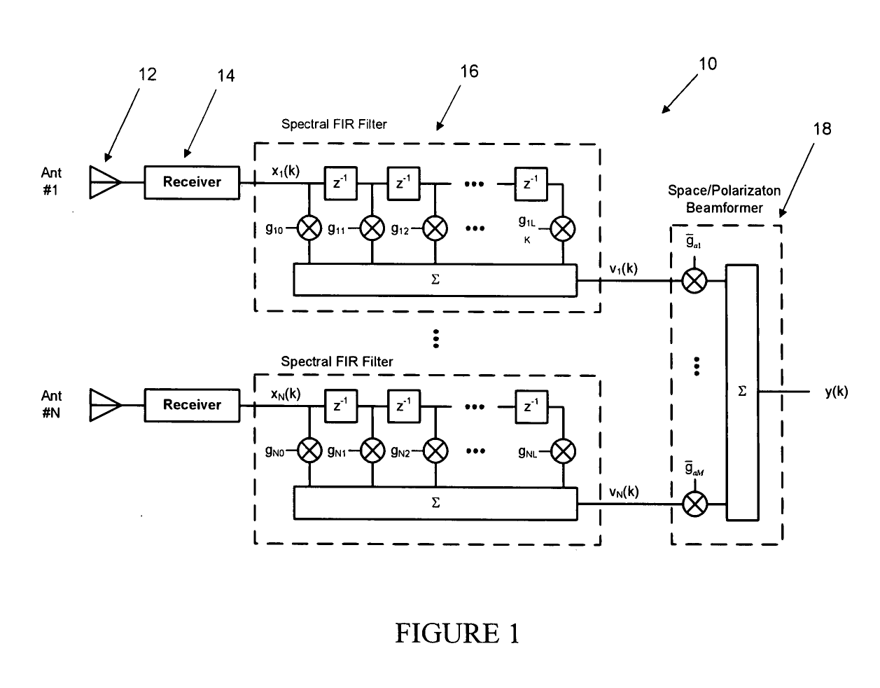

A block diagram of the Spatial/Temporal/Polarization (STP) adaptive array processing structure 10 is shown in FIG. 1. The adaptive array processing structure 10 includes an antenna array 12 consisting of N elements of possibly arbitrary locations and varying polarizations. A receiver 14 in each antenna channel provides frequency conversion, band pass filtering, and digitization of the received signals. The digitized array signals, xₙ(k), from the receiver 14 are processed by a set of Finite Impulse Response (FIR) filters 16 attached to each antenna element port. The FIR filters 16 provide spectral band stop (or nulls) to reject the interfering signals (IS), and band pass functions to pass the signals of interest (SOI). The FIR filters 16 also compensate for dispersion effects due to the delay spread across large arrays to increase the effective bandwidth of the array. The outputs of the FIR filters, vₙ(k), are combined in an array beamformer 18 to produce an adapted array output signal, y(k).

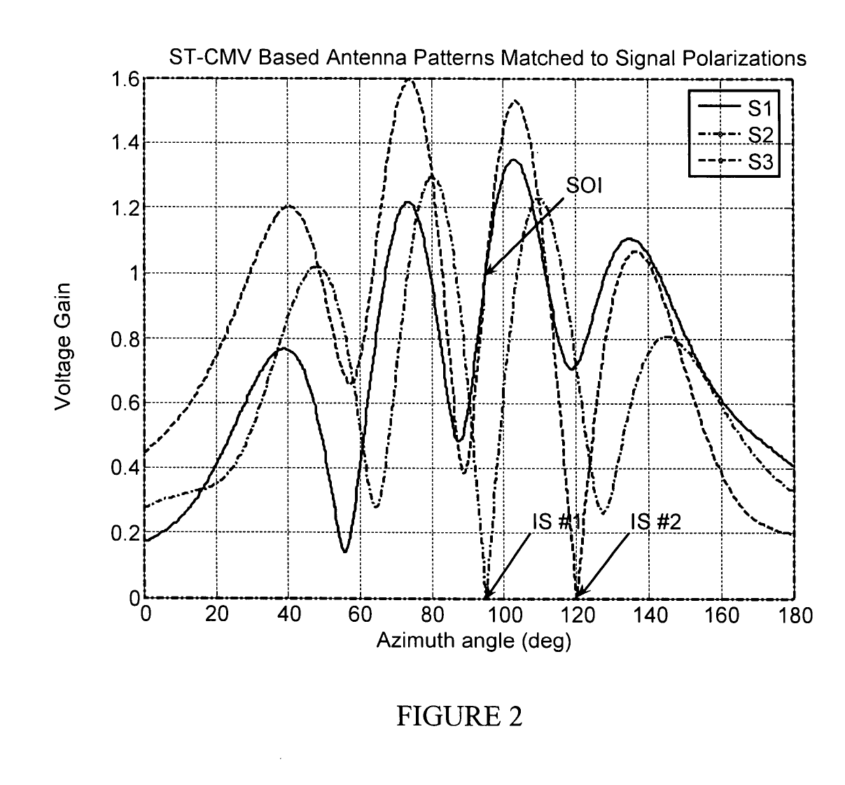

The adapted array 10 has a response that can be mapped into a spatial antenna gain pattern as a function of angle and polarization. As an example, a one dimensional array pattern for a two element dual polarized array is shown in FIG. 2. The SOI is a vertically polarized pulse signal located at an angle of 95 degrees. There are two interfering signals, a left hand circularly polarized narrow band Gaussian noise (NBGN) signal located at 95 degrees and another slant right polarized NBGN signal located at 120 degrees. Here, the pattern exhibits spatial nulls for the polarization matched to the interfering signals in the direction of the two interfering signals, IS#1 and IS#2. Also note that the antenna pattern has unity gain at the polarization and direction of the signal of interest, SOI. While only two domains are highlighted in FIG. 2 (viz. spatial and polarization), the present invention contains provisions to form nulls and pass bands in three domains: spatial, spectral and polarization.

Signal Model

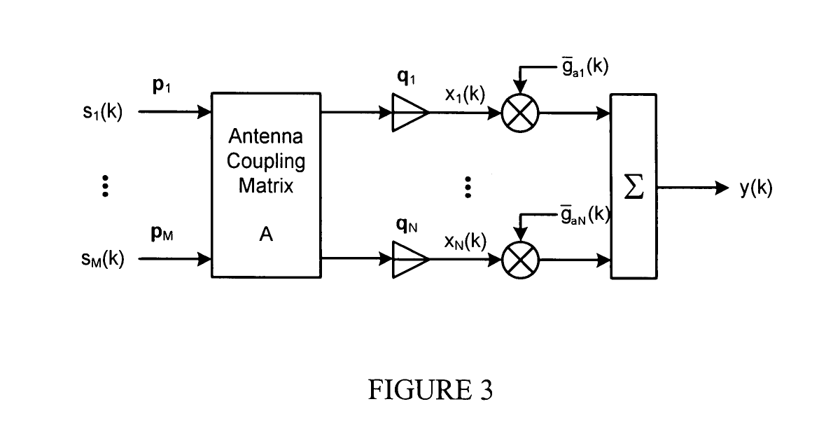

A functional block diagram showing the source signals, antenna coupling matrix, antenna structure, and adaptive beamformer for an adaptive array without the FIR filters is shown in FIG. 3. A discrete time representation will be used for all signals with out loss of generality, but of course, all actual signals will be continuous time in nature prior to the digitization process. Signals s₁(k), s₂(k), . . . , s_{M}(k) represent M discrete time source signals with sample index k received by an antenna array of N elements, each with polarization qₙ. It is assumed that the M signals are distributed spatially and each has a unique polarization, pₘ. The antenna array response matrix, A(k), defines the coupling between the M source signals received by the N antenna elements and the element signals at the N antenna output ports, x₁(k), x₂(k), . . . , X_{N}(k). The antenna element signals are multiplied by adaptive complex weights \overline{g}ₐ₁(k), \overline{g}ₐ₂(k), . . . , \overline{g}_{aN}(k) and summed to form the adapted array output y(k). Note that the over bar indicates the complex conjugate, which is used to standardize the notation that appears later in the disclosure. The weights are indicated to be possibly time varying to account for adaptation transients for cases of dynamic environments. In many situations however, fixed coefficients are assumed for analysis purposes.

The antenna output can be expressed mathematically in matrix form as:

$$[ \begin{matrix}{x}_{1} ( k ) \\ {x}_{2} ( k ) \\ ⋮ \\ {x}_{M} ( k )\end{matrix} ] = [ \begin{matrix}{a}_{11} ( k ) & {a}_{12} ( k ) & ⋯ & {a}_{1 N} ( k ) \\ {a}_{21} ( k ) & {a}_{22} ( k ) & ⋯ & {a}_{21} ( k ) \\ ⋮ & ⋮ & & ⋮ \\ {a}_{M 1} ( k ) & {a}_{M 2} ( k ) & ⋯ & {a}_{MN} ( k )\end{matrix} ] [ \begin{matrix}{s}_{1} ( k ) \\ {s}_{2} ( k ) \\ ⋮ \\ {s}_{N} ( k )\end{matrix} ] + [ \begin{matrix}{n}_{1} ( k ) \\ {n}_{2} ( k ) \\ ⋮ \\ {n}_{N} ( k )\end{matrix} ] \qquad ( 1 )$$

where nₙ(k) represents additive noise terms for each receiver channel. Let

$$\begin{matrix}s ( k ) = {[ {s}_{1} ( k ) , {s}_{2} ( k ) , … , {s}_{N} ( k ) ]}^{t} \\ x ( k ) = {[ {x}_{1} ( k ) , {x}_{2} ( k ) , … , {x}_{M} ( k ) ]}^{t} \\ n ( k ) = {[ {n}_{1} ( k ) , {n}_{2} ( k ) , … , {n}_{N} ( k ) ]}^{t} \\ g ( k ) = {[ {g}_{1} ( k ) , {g}_{2} ( k ) , … , {g}_{M} ( k ) ]}^{t} \\ and & ( 2 ) \\ A ( k ) = [ \begin{matrix}{a}_{11} ( k ) & {a}_{12} ( k ) & ⋯ & {a}_{1 N} ( k ) \\ {a}_{21} ( k ) & {a}_{22} ( k ) & ⋯ & {a}_{21} ( k ) \\ ⋮ & ⋮ & & ⋮ \\ {a}_{M 1} ( k ) & {a}_{M 2} ( k ) & ⋯ & {a}_{MN} ( k )\end{matrix} ] & ( 3 )\end{matrix}$$

In a more compact matrix-vector form, the antenna outputs, x(k), and the receiver output, y(k), becomes
x(k)=A(k)s(k)+n(k)
y(k)=g(k)*x(k)=g(k)*A(k)s(k) (4)
where the asterisk * indicates the Hermetian or complex conjugate transpose. From this point on, the notation indicating the explicit dependence on the sample index k is dropped, but it assumed that the vector and matrix quantities will generally be time-varying.

Derivation of the Array Coupline Matrix

The columns of the A matrix, aₘ, where A=[a₁, a₂, . . . , a_{M}], are usually referred to as the array response or antenna steering vectors for the m-th signal. These vectors will be a function of the polarization and spatial orientation of the emitter and the directional gain, polarization and displacement of the receive antenna elements.

First, consider the effects of signal and antenna polarization. Let the vector pₘ be the polarization vector for the m-th signal and the vector qₙ be the polarization vector for the n-th antenna element. These polarization vectors are 2×1 complex vectors representing the normalized electric field components alligned with a pair of unit vectors orthogonal to the line of sight (LOS) or Poynting vector. Typically, these unit vectors may be associated with the vertical and horizontal polarizations respectively. The response xₙ(t) of the n-th antenna with polarization qₙ to the m-th signal sₘ with polarization pₘ is given by
xₙ=qₙ*pₘsₘ (5)

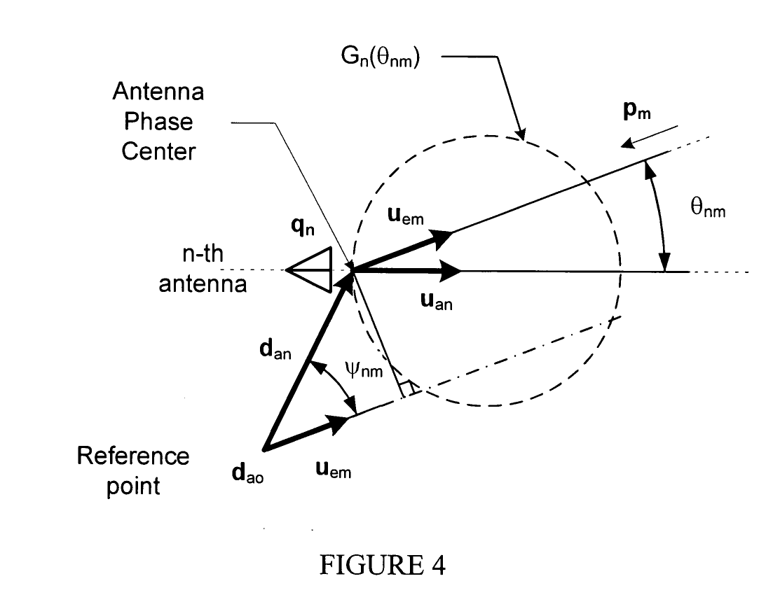

Next, consider the effects of antenna directivity and displacement. Referring to FIG. 4, assume the directional gain of the antenna elements G(θ) is a symmetrical function of the cone angle θ about the orientation of the boresight unit vector uₐ. Let vector dₐₙ specify the location of the phase center of the n-th antenna relative to some reference point dₐₒ, let unit vector uₐₙ specify the orientation of the antenna boresight direction of the n-th antenna, let unit vector qₙ define the polarization of the n-th antenna, and let Gₙ(θₙₘ) define the directional gain characteristics of the n-th antenna as a function of cone angle θₙₘ. Let uₑₘ be the unit vector specifying the direction of the incident signal from the m-th emitter and unit vector pₘ specify the polarization of this incident signal. Let angle θₙₘ be the cone angle between the unit vectors uₐₙ and uₑₘ. Let ψₙₘ be the cone angel between the vectors uₑₘ and dₐₙ.

Angles θₘₙ and ψₘₙ are given by

$${θ}_{n m} = {cos}^{- 1} ( {u}_{em}^{t} {u}_{an} ) \\ {ψ}_{n m} = {cos}^{- 1} ( \frac{{d}_{am}^{t} {u}_{em}}{{[ {d}_{an}^{t} {d}_{an} ]}^{1 / 2}} ) \qquad ( 6 )$$

Let τₙₘ be the differential delay between the signal received at the reference point dₐₒ and the antenna phase center dₐₙ of the n-th antenna. This differential delay is given by

$${τ}_{n m} = - \frac{1}{c} {d}_{an}^{t} {u}_{em} \qquad ( 7 )$$

For narrow band signals with carrier frequency fₒ, the differential delay can be expressed as an equivalent phase shift given by

$$Δ {ϕ}_{n m} = - \frac{2 π {f}_{o}}{c} {d}_{an}^{t} {u}_{em} \qquad ( 8 )$$

where c is the speed of light.

Now, the effects of polarization, directivity and displacement can be combined to form the elements of the A matrix:
aₙₘ=qₙ*pₘGₙ(θ)exp(−jΔφₙₘ) (9)

Constrained Minimum Variance

One way to adapt the antenna system to suppress interference is through the use of a Constrained Minimum Variance (CMV) method. This method attempts to minimize the expected value of the magnitude squared of output y(k) while constraining the weights gₐ to meet some specified gain and polarization in the direction of the SOI. Expressed mathematically, the method attempts to:

$${min}_{g} E \{ {\vert y ( k ) \vert}^{2} \} \qquad ( 10 )$$

subject to the constraint
gₐ*aₒ=cₒ (11)
where aₒ is the steering vector to pass the SOI and cₒ is some specified net array gain.

The expected value of the squared output, using (4) is given by

$$\begin{matrix}E \{ {\vert y ( k ) \vert}^{2} \} = E \{ {[ {g}^{*} As ]}^{*} [ {g}^{*} As ] \} \\ = E \{ {[ {s}^{*} Ag ]}^{*} [ {s}^{*} Ag ] \} \\ = E \{ {g}^{*} {A}^{*} {ss}^{*} Ag ] \} \\ = {g}^{*} {A}^{*} E \{ {ss}^{*} \} Ag \\ = {g}^{*} {A}^{*} {R}_{s} Ag\end{matrix} \qquad ( 12 )$$

where Rₛ is the covariance of the M emitter signals.

Generally, neither the coupling matrix A nor the signal covariance Rₛ will be known. However, (12) can also be expressed in terms of the signals available at the antenna ports.

$$\begin{matrix}E \{ {\vert y ( k ) \vert}^{2} \} = E \{ {[ {g}^{*} x ]}^{*} [ {g}^{*} x ] \} \\ = E \{ {[ {x}^{*} g ]}^{*} [ {x}^{*} g ] \} \\ = E \{ {g}^{*} {xx}^{*} g ] \} \\ = {g}^{*} E \{ {xx}^{*} \} g \\ = {g}^{*} {R}_{x} g\end{matrix} \qquad ( 13 )$$

Comparing to (12), it is obvious that Rₓ=A*RₛA. Fortunately, the covariance matrix Rₓ can be estimated directly from samples of signals obtained from the N antenna channels.

A cost function J(g) can be formed using the Lagrange multiplier method to account for the constraint.
J(gₐ)=gₐ*Rₓgₐ+λ(gₐ*−cₒ) (14)
Differentiating this with respect to g* and λ produces

$$\frac{\partial }{\partial {g}^{*}} J ( g ) = {R}_{x} g + {λa}_{o} \\ \frac{\partial }{\partial λ} J ( g ) = {g}^{*} {a}_{o} - {c}_{o} \qquad ( 15 )$$

Setting each of the equations in (15) equal to zero, and using matrix form produces

$$[ \begin{matrix}{R}_{x} & {a}_{o} \\ {a}_{o}^{*} & 0\end{matrix} ] [ \begin{matrix}{g}_{a} \\ λ\end{matrix} ] = [ \begin{matrix}0 \\ {c}_{o}\end{matrix} ] \qquad ( 16 )$$

where the partitioning preserves compatible dimensions. Equation (16) can now be solved for g and λ as

$$[ \begin{matrix}{g}_{a} \\ λ\end{matrix} ] = {[ \begin{matrix}{R}_{x} & {a}_{o} \\ {a}_{o}^{*} & 0\end{matrix} ]}^{- 1} [ \begin{matrix}0 \\ {c}_{o}\end{matrix} ] \qquad ( 17 )$$

An explicit solution for g can be found by solving separately for g and λ from (16). From the first row in ( 16)
Rₓgₐ=a₀λ=0
Rₓgₐ=−aₒλ (18)
gₙ=−Rₓ⁻¹aₒλ
Using this result in the second row of (16) produces

$${g}_{a}^{*} {a}_{0} = {{c}_{0} \\ ( - {R}_{x}^{- 1} {a}_{0} λ )}^{*} {a}_{0} = {c}_{0} \\ - {λ}^{*} {a}_{0}^{*} ( {R}_{x}^{- 1} ) {a}_{0} = {c}_{0} \\ λ = \frac{- {c}_{0}}{{a}_{0}^{*} {R}_{x}^{- 1} {a}_{0}} \qquad ( 19 )$$

Combining results, we get a direct solution for g without solving explicitly for the λ.

$${g}_{a} = \frac{{c}_{o} {R}^{- 1} {a}_{o}}{{a}_{o}^{*} {R}^{- 1} {a}_{o}} \qquad ( 20 )$$

Note that cₒ is typically set to unity. Since cₒ is just a scale factor, its value has no direct effect other than to set the magnitude of the output y(k).

The Space-Time-Polarization (STP) Model

As the spacing of the antennas increase, the ability to suppress wideband signals is reduced due to the delay spread in signals received at the various antennas. This effect is characterized as the bandwidth of an array antenna, Bₐₙₜ, and is nominally equated to the reciprocal of the delay spread τ_{Δ}, i.e. Bₐₙₜ˜1/τ_{Δ} across the array. To counter the bandwidth limitation, adaptive FIR equalizers can be employed to compensate for the delay spread in the received signal components to provide a wideband adaptive array. It also provides additional degrees of freedom in the frequency domain to suppress interfering signals that are not matched to the SOI spectrum but may co-exist within the receiver bandwidth.

A block diagram of the proposed space-time-polarization processing is shown in FIG. 1. The time/frequency processing is accomplished by the FIR filters attached to each antenna port while the spatial processing is accomplished by the beam forming spatial filter attached to the output of the FIR filters. If the antennas have polarization diversity, then the adaptive array will also form nulls and lobes in the polarization domain. If the polarizations of all antenna elements are the same, then this is equivalent to a conventional adaptive array and no polarization adaptation will take place.

In order to account for the signal bandwidth effects, we need to re-examine the development of the discrete time signals, xₙ(k), from the continuous time signals, xₙ(t), at the antenna array ports. The continuous time signals, ignoring the additive noise terms, are given by

$${x}_{n} ( t ) = {\sum }_{m = 1}^{M} {q}_{n}^{*} {p}_{m} G ( {θ}_{n m} ) {s}_{m} ( t - {τ}_{n m} ) \qquad ( 21 )$$

where, as before, qₙ is the antenna element polarization, pₘ is the signal polarization, Gₙ(θₙₘ) is the antenna gain factor for the cone angle θₙₘ, and τₙₘ is the differential delay. The effects of the time delays can also be accounted for by including a delay filter function δₘₙ(t−τ).

$${x}_{n} ( t ) = {\sum }_{m = 1}^{M} {q}_{n}^{*} {p}_{m} G ( {θ}_{n m} ) δ ( t - {τ}_{n m} ) * {s}_{m} ( t ) \qquad ( 22 )$$

The real form of signal sₘ(t) is given by
sₘ(t)=aₘ(t)cos(ωₘt+bₘ(t)) (23)
where aₘ(t) and bₘ(t) are the amplitude and phase modulation terms respectively. The analytic form of the input signal is given by

$$\begin{matrix}{s}_{m} ( t ) = {a}_{m} ( t ) {ⅇ}^{j ( {ω}_{m} t + {b}_{m} ( t ) )} \\ = {c}_{m} ( t ) {ⅇ}^{j {ω}_{m} t}\end{matrix} \qquad ( 24 )$$

where cₘ(t)=aₘ(t)exp(jbₘ(t)) is the complex modulation or envelope function.

Applying (24) to (21), we have

$$\begin{matrix}{x}_{n} ( t ) = {\sum }_{m = 1}^{M} {q}_{n}^{*} {p}_{m} G ( {θ}_{n m} ) {c}_{m} ( t - {τ}_{n m} ) {ⅇ}^{{jω}_{m} ( t - {τ}_{n m} )} \\ = {\sum }_{m = 1}^{M} {q}_{n}^{*} {p}_{m} G ( {θ}_{n m} ) {c}_{m} ( t - {τ}_{n m} ) {ⅇ}^{- j {ω}_{m} {τ}_{n m}} {ⅇ}^{j {ω}_{m} t} \\ = {\sum }_{m = 1}^{M} {a}_{n m} {c}_{m} ( t - {τ}_{n m} ) {ⅇ}^{j {ω}_{m} t}\end{matrix} \qquad ( 25 )$$

Note that the aₙₘ terms are the same as those found in (9). If the effects of the delay in the modulation terms is negligible, i.e. cₘ(t−τₙₘ)≈cₘ(t), then (25) reduces to the same form of the signal component used in expression (1). That is:

$$\begin{matrix}{x}_{n} ( t ) = {\sum }_{m = 1}^{M} {a}_{n m} {c}_{m} ( t - {τ}_{n m} ) {ⅇ}^{j {ω}_{m} t} \\ \approx {\sum }_{m = 1}^{M} {a}_{n m} {c}_{m} ( t ) {ⅇ}^{j {ω}_{m} t} \\ = {\sum }_{m = 1}^{M} {a}_{n m} {s}_{m} ( t )\end{matrix} \qquad ( 26 )$$

This generally will be the case when the bandwidth occupied by all of the signals is less than the reciprocal of the maximum delay spread. However, if the effects of the delays in the modulation terms are not negligible then (25) must be used to model the signals at the antenna ports.

The array element signals are processed by the receiver units that down convert them to a baseband format given by

$$\begin{matrix}{x}_{n} ( t ) = {\sum }_{m = 1}^{M} {a}_{n m} {c}_{m} ( t - {τ}_{n m} ) {ⅇ}^{j {ω}_{m} t} {ⅇ}^{- j {ω}_{LO} t} \\ = {\sum }_{m = 1}^{M} {a}_{n m} {c}_{m} ( t - {τ}_{n m} ) {ⅇ}^{j {ω}_{Δ m} t}\end{matrix} \qquad ( 27 )$$

where ω_{Δm}=ωₘ−ω_{LO} is the baseband offset frequency. This offset frequency is often assumed to be zero, but with fixed local oscillator (LO) frequencies and multiple signals, this is not normally the case. It should be noted that the effects of the offset frequencies contribute to the total bandwidth of the signal and often are more significant than the modulation bandwidth of the signals themselves. As a general rule, it is assumed that the bandwidth of the received signals is as wide as the total receiver bandwidth, whether occupied or not.

The signals are then digitized to generate the discrete time samples where xₙ(k) is a sampled version of the continuous time signal given in (27) (i.e. xₙ(k)=xₙ(t=kT)).

$${x}_{n} ( k ) = {\sum }_{m = 1}^{M} {a}_{n m} {c}_{n m} ( k ) {ⅇ}^{j {ω}_{Δ m} {T}_{s} k} \qquad ( 28 )$$

Note that in the discrete time form, the function cₙₘ(k) includes the effects of the delay term τₙₘ.

With L+1 tap FIR filters located in each antenna channel, the signal at the output of the FIR filters for the n-th antenna channel, vₙ(k), is given by

$${v}_{n} ( k ) = {\sum }_{t = 0}^{L} {g}_{nl} {x}_{n} ( k - l ) \qquad ( 29 )$$

The output of the spatial beam former, y(k), is given by

$$y ( k ) = {\sum }_{n = 0}^{N} {\overline{g}}_{an} {v}_{n} ( k ) \qquad ( 30 )$$

The FIR and spatial beam former can be combined into a single set of FIR coefficients, hₙl, having the form

$$\begin{matrix}y ( k ) = {\sum }_{n = 1}^{N} {\overline{g}}_{an} {\sum }_{l = 0}^{L} {g}_{nl} {x}_{n} ( k - l ) \\ = {\sum }_{n = 1}^{N} {\sum }_{l = 0}^{L} {h}_{nl} {x}_{n} ( k - l )\end{matrix} \qquad ( 31 )$$

where hₙₗ=\overline{g}ₐₙgₙₗ. Substituting (28) into (31) provides

$$\begin{matrix}y ( k ) = {\sum }_{n = 1}^{N} {\sum }_{l = 0}^{L} {h}_{nl} {\sum }_{m = 1}^{M} {a}_{n m} {c}_{n m} ( k - l ) {ⅇ}^{{jω}_{Δ m} {T}_{s} ( k - l )} \\ = {\sum }_{n = 1}^{N} {\sum }_{l = 0}^{L} {\sum }_{m = 1}^{M} {h}_{nl} {a}_{n m} {c}_{n m} ( k - l ) {ⅇ}^{{jω}_{Δ m} {T}_{s} ( k - l )}\end{matrix} \qquad ( 32 )$$

This additional set of coefficients offered by (32) provides the extra degrees of freedom to compensate for the delay spread.

The output of the n-th FIR filter can be expressed in block vector-matrix notation for Q consecutive samples as

$$[ \begin{matrix}{v}_{n} ( k ) \\ {v}_{n} ( k + 1 ) \\ ⋮ \\ {v}_{n} ( k + Q - 1 )\end{matrix} ] = [ \begin{matrix}{x}_{n} ( k ) & {x}_{n} ( k - 1 ) & ⋯ & {x}_{n} ( k - L ) \\ {x}_{n} ( k + 1 ) & {x}_{n} ( k ) & ⋯ & {x}_{n} ( k - L + 1 ) \\ ⋮ & ⋮ & & ⋮ \\ {x}_{n} ( k + Q - 1 ) & {x}_{n} ( k + Q - 2 ) & ⋯ & {x}_{n} ( k + Q - L - 1 )\end{matrix} ] [ \begin{matrix}\begin{matrix}\begin{matrix}{\overline{g}}_{a 1} \\ {\overline{g}}_{a 2}\end{matrix} \\ ⋮\end{matrix} \\ {\overline{g}}_{aN}\end{matrix} ] \\ or \\ \begin{matrix}y = [ {v}_{1} {v}_{2} … {v}_{N} ] {\overline{g}}_{a} \\ = V {\overline{g}}_{a}\end{matrix} \qquad ( 33 )$$

In a similar notation, the block form of the output y(k) is given by

$$[ \begin{matrix}{y}_{n} ( k ) \\ {y}_{n} ( k + 1 ) \\ ⋮ \\ {y}_{n} ( k + Q - 1 )\end{matrix} ] = [ \begin{matrix}{v}_{1} ( k ) & {v}_{2} ( k ) & ⋯ & {v}_{N} ( k ) \\ {v}_{1} ( k + 1 ) & {v}_{2} ( k + 1 ) & ⋯ & {v}_{N} ( k + 1 ) \\ ⋮ & ⋮ & & ⋮ \\ {v}_{1} ( k + Q - 1 ) & {v}_{2} ( k + Q - 1 ) & ⋯ & {v}_{N} ( k + Q - 1 )\end{matrix} ] [ \begin{matrix}{g}_{n 0} \\ {g}_{n 1} \\ ⋮ \\ {g}_{nL}\end{matrix} ] \\ or \\ {v}_{n} = {X}_{n} {g}_{n} \qquad ( 34 )$$

Substituting (33) into (34) results in

$$\begin{matrix}y = [ {X}_{1} {g}_{1} {X}_{2} {g}_{2} … {X}_{N} {g}_{N} ] {\overline{g}}_{a} \\ = [ {X}_{1} {\overline{g}}_{a 1} {g}_{1} + {X}_{2} {\overline{g}}_{a2} {g}_{2} + … + {X}_{N} {\overline{g}}_{aN} {g}_{N} ] \\ = [ {X}_{1} {h}_{1} + {X}_{2} {h}_{2} + … + {X}_{N} {h}_{N} ] \\ = [ \begin{matrix}{X}_{1} & {X}_{2} & ⋯ & {X}_{N}\end{matrix} ] [ \begin{matrix}{h}_{1} \\ {h}_{2} \\ ⋮ \\ {h}_{N}\end{matrix} ] \\ = {X}_{X} h\end{matrix} \qquad ( 35 )$$

Note that h=[h₁^{t}, h₂^{t}, . . . , h_{N}^{t}]^{t} is the vectorized version of the modified tap weights that include both the FIR filter weights and the adaptive array weights.

The expected or average value of the output power is given by

$$\begin{matrix}E \{ \vert y ( k ) \vert \approx \frac{1}{Q} {y}^{*} y \\ = {\frac{1}{Q} [ Xh ]}^{*} [ Xh ] \\ = \frac{1}{Q} [ {h}^{*} {X}^{*} Xh ] \\ = {h}^{*} {R}_{X} h\end{matrix} \qquad ( 36 )$$

Note that R_{X} is the time-space correlation matrix for the signals at the output of all of the delay taps.

$$\begin{matrix}{R}_{X} \approx {\frac{1}{Q} [ {X}_{1} , {X}_{2} , … , {X}_{N} ]}^{*} [ {X}_{1} , {X}_{2} , … , {X}_{N} ] \\ = \frac{1}{Q} [ \begin{matrix}{X}_{1}^{*} {X}_{1} & {X}_{1}^{*} {X}_{2} & ⋯ & {X}_{1}^{*} {X}_{N} \\ {X}_{2}^{*} {X}_{1} & {X}_{2}^{*} {X}_{2} & & ⋮ \\ ⋮ & & & \\ {X}_{N}^{*} {X}_{1} & ⋯ & & {X}_{N}^{*} {X}_{N}\end{matrix} ]\end{matrix} \qquad ( 37 )$$

The STP-CMV Method

The STP-CMV method adjusts the weights {hₙ} to minimize the expected or average output power of signal y(k) subject to a set of constraints in both the spatial and frequency domains at the signal of interest. The STP-CNFV method can be expressed as follows

$${min}_{h} {h}^{*} {R}_{X} h + {λ}^{t} S ( h , θ , p , f ) \qquad ( 38 )$$

where S(h,θ,p,f) is a constraint function of the desired look angles θ, polarization p and set of frequencies f. Note that the constraint is necessary to suppress the solution h=0, which would certainly minimize the output but would not provide any useful output.

Many approaches can be utilized to address these constraints. One way to address the set of constraints is to consider the spatial and frequency domains separately as suggested in FIG. 1. The following approach is representative of a number of viable methods to treat the constraints.

First consider the frequency domain constraints. The frequency response, H(jω), at frequency ω of a L+1 tap FIR filter with tap weights g₀, g₁, . . . , g_{L} is given by

$$H ( jω ) = {\sum }_{l = 0}^{L} {g}_{l} {ⅇ}^{- jω {T}_{s} l} \qquad ( 39 )$$

where Tₛ is the sample interval. The FIR tap weights, gₙ, for each channel can be constrained to meet gain requirements at specified frequencies {f₁, f₂, . . . , f_{K}} as follows:
Wₙgₙ=cₙ (40)
where Wₙ is a K by L+1 discrete Fourier transform (DFT) matrix using (39) with the K rows corresponding to the frequency points {f₁, f₂, . . . f_{K}} and cₙ is a K by 1 vector of the filter gains to be met at each frequency point for the n-th channel. In general, the frequencies and gain set points can be different for each channel, but in order to set the spatial gain as presented in the following discussion, Wₙ and cₙ should be the same for all channels. That is Wₙ=W and cₙ=c for all n. In this case (40) has the form

$$[ \begin{matrix}1 & {ⅇ}^{- j2π {f}_{1} / {T}_{s}} & ⋯ & {ⅇ}^{- j2π {f}_{1} L / {T}_{s}} \\ 1 & {ⅇ}^{- j2π {f}_{2} / {T}_{s}} & ⋯ & {ⅇ}^{- j2π {f}_{2} L / {T}_{s}} \\ ⋮ & ⋮ & ⋮ & ⋮ \\ 1 & {ⅇ}^{- j2π {f}_{L} / {T}_{s}} & ⋯ & {ⅇ}^{- j2π {f}_{L} L / {T}_{s}}\end{matrix} ] [ \begin{matrix}{g}_{n 0} \\ {g}_{n 1} \\ ⋮ \\ {g}_{nL}\end{matrix} ] = [ \begin{matrix}{c}_{1} \\ {c}_{2} \\ ⋮ \\ {c}_{K}\end{matrix} ] \qquad ( 41 )$$

or since W and c are fixed
Wgₙ=c (42)

The spatial domain constraints fix the antenna gain in the direction of the SOI. These constraints have the form
gₐ*aₒ=cₒ (43)
where aₒ is a steering vector that is a function of the desired look angle and polarization and cₒ is the specified scalar gain. Note that this spatial gain can be guaranteed only at the frequencies specified in the setting of the frequency response. This is due to the fact that the channel gains will be identical at these frequencies and the spatial beamformer effectively “sees” the same signals that appear at the antenna ports, but only at the specified frequencies.

The composite CMV cost function including output power and constraints now becomes

$${min}_{{g}_{a} , {g}_{1} , {…g}_{N}} {h}^{*} {R}_{X} h + {λ}_{a} ( {g}_{a}^{*} {a}_{o} - {c}_{o} ) + {λ}_{1}^{′} ( W {g}_{1} - c ) + … + {λ}_{N}^{′} ( {Wg}_{N} - c ) \qquad ( 44 )$$

This form is not particularly attractive since it is expressed in both the {gₐ, g₁, g₂, . . . , g_{N}} and the {h₁, h₂, . . . , h_{N}} solution sets. However, a few assumptions and restrictions result in a relatively simple expression for the constraints.

First, note that from the substitution hₙₖ=\overline{g}ₐₙgₙₖ made in (31), the vectorized relationship between hₙgₐ and gₙ is given by

$${h}_{n} = [ \begin{matrix}{\overline{g}}_{an} {g}_{n 0} \\ {\overline{g}}_{an} {g}_{n 1} \\ ⋮ \\ {\overline{g}}_{an} {g}_{n K}\end{matrix} ] = {\overline{g}}_{an} {g}_{n} \qquad ( 45 )$$

Now consider the following set of equations.

$$[ \begin{matrix}W {h}_{1} \\ W {h}_{2} \\ ⋮ \\ W {h}_{N}\end{matrix} ] = [ \begin{matrix}W [ {I}_{L} , {0}_{L} , … , {0}_{L} ] h \\ W [ {0}_{L} , {I}_{L} , … , {0}_{L} ] h \\ ⋮ \\ W [ {0}_{L} , {0}_{L} , … , {I}_{L} , ] h\end{matrix} ] = [ \begin{matrix}{\overline{g}}_{a 1} W {g}_{1} \\ {\overline{g}}_{a 2} W {g}_{2} \\ ⋮ \\ {\overline{g}}_{a N} W {g}_{N}\end{matrix} ] = [ \begin{matrix}{\overline{g}}_{a 1} c \\ {\overline{g}}_{a 2} c \\ ⋮ \\ {\overline{g}}_{aN} c\end{matrix} ] \qquad ( 46 )$$

where I_{L} and O_{L} are L×L identity and zero matrices respectively.

If the frequency response of all FIR filters are specified to be unity at a single frequency fₒ (i.e. the carrier frequency of the SOI), then W=w(fₒ)=w is a single 1×(L+1) row vector and c=1 becomes a scalar for all n. Now (46) reduces to

$$\begin{matrix}{W}_{w} h = {\overline{g}}_{a} \\ where & ( 47 ) \\ {W}_{w} = [ \begin{matrix}w & 0 & ⋯ & 0 \\ 0 & w & & ⋮ \\ ⋮ & & & \\ 0 & ⋯ & & w\end{matrix} ] & ( 48 )\end{matrix}$$

Transposing (47) and post-multiplying by the steering vector aₒ produces
h^{t}W_{W}^{t}aₒ=gₐ*aₒ=cₒ (49)
Now incorporating this constraint into the STP-CMV formulation produces

$$\begin{matrix}{min}_{h} C = {h}^{*} {R}_{X} h + λ ( {h}^{t} {W}_{W}^{t} {a}_{o} - {c}_{o} ) \\ = {h}^{*} {R}_{X} h + λ ( {h}^{*} {W}_{W}^{*} {\overline{a}}_{o} - {\overline{c}}_{o} )\end{matrix} \qquad ( 50 )$$

Taking the derivatives with respect to h* and λ produces

$$\frac{\partial C}{\partial {h}^{*}} = {R}_{X} h + λ {W}_{W}^{*} {\overline{a}}_{o} \\ \frac{\partial C}{\partial λ} = {h}^{*} {W}_{W}^{*} {\overline{a}}_{o} - {\overline{c}}_{o} \qquad ( 51 )$$

Setting these equations to zero produces

$$[ \begin{matrix}{R}_{X} & {W}_{W}^{*} {\overline{a}}_{o} \\ {a}_{o}^{t} {W}_{w} & 0\end{matrix} ] [ \frac{h}{λ} ] = [ \frac{0}{{c}_{o}} ] \qquad ( 52 )$$

This equation can be solved directly to produce

$$[ \frac{h}{λ} ] = {[ \begin{matrix}{R}_{X} & {W}_{W}^{*} {\overline{a}}_{o} \\ {a}_{o}^{t} {W}_{w} & 0\end{matrix} ]}^{- 1} [ \frac{0}{{c}_{o}} ] \qquad ( 53 )$$

Again, a direct solution for h exists. From the first row in (52)
h=−λR_{X}⁻¹W_{W}*\overline{a}ₒ (54)
Using this result in the second row in (52)

$$λ = - \frac{{c}_{o}}{{a}_{o}^{t} {W}_{W} {R}_{X}^{- 1} {W}_{W}^{*} {\overline{a}}_{o}} \qquad ( 55 )$$

Finally, plugging (55) into (54) results in

$$h = \frac{{c}_{o} {R}_{X}^{- 1} {W}_{W}^{*} {\overline{a}}_{o}}{{a}_{o}^{t} {W}_{W} {R}_{X}^{- 1} {W}_{W}^{*} {\overline{a}}_{o}} \qquad ( 56 )$$

The original FIR filter weights gₙ and spatial weighting vector gₐ can be recovered as follows. From (40), recall that the FIR coefficients were constrained to provide set gains at specified frequencies.
wgₙ=cₙ (57)

Next, applying the weight vector w to each of the composite FIR vectors hₙ, we have
whₙ=\overline{g}ₐₙwgₙ=cₙ\overline{g}ₐₙ (58)
Solving the latter for gₐ and gₙ provides the desired results.

$${g}_{a} = [ \begin{matrix}\frac{\overline{w} {\overline{h}}_{1}}{{\overline{c}}_{2}} \\ \frac{\overline{w} {\overline{h}}_{2}}{{\overline{c}}_{2}} \\ ⋮ \\ \frac{\overline{w} {\overline{h}}_{N}}{{\overline{c}}_{N}}\end{matrix} ] \\ {g}_{n} = \frac{{h}_{n}}{{\overline{g}}_{an}} = \frac{{c}_{n} {h}_{n}}{{wh}_{n}} \qquad ( 59 )$$

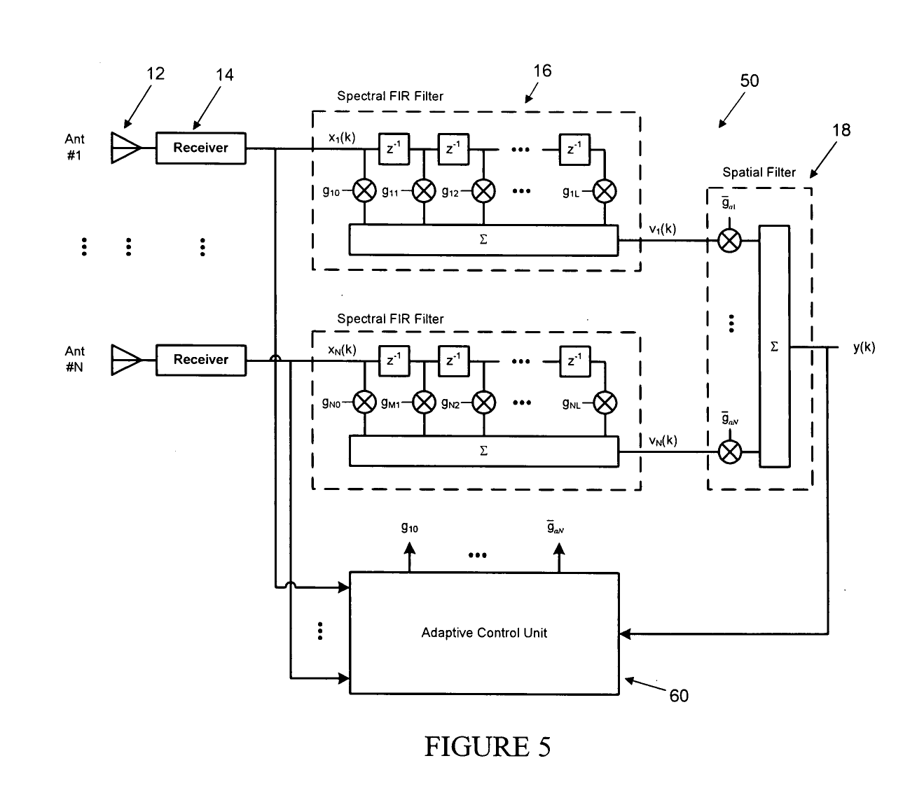

FIG. 5 shows a block diagram of the adaptive array 50 with CMV/STP adaptive control unit 60. The inputs to the adaptive control unit 60 are the signals at the N antenna output ports, x₁(k), x₂(k), . . . , x_{N}(k), and the combined output, y(k). In one form of the control, indicated by (56), the covariance matrix R_{X} is computed from the signals xₙ(k) obtained directly from the antenna ports, and the steering vector ao and carrier frequency fₒ needed to form W_{W} can be obtained from the signal environment or from apriori knowledge of the SOI. The outputs from the adaptive control unit 60 are the FIR filter weights gₙ and the spatial weighting vector gₐ.

It should be noted that an alternate form of the solution, not discussed here, can be implemented in recursive form using a gradient method. This requires the output signal y(k) which is included in FIG. 5 as an input to the adaptive control unit 60.

Simulation Results

A series of simulation runs were made to validate the method and system presented in the previous sections and to demonstrate the potential performance of the proposed approach.

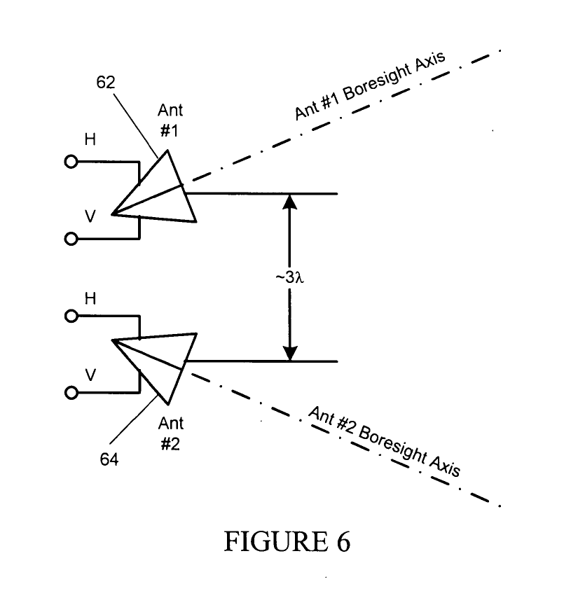

The simulated ESM antenna system used in this simulation is shown in FIG. 6. The antenna array consists of two dual polarized elements 62, 64 separated by approximately three wavelengths (i.e. 3λ) and are squinted outward by 22.5 degrees. Since each antenna 62, 64 has vertical, V, and horizontal, H, polarized outputs, a total of four channels are required for the ESM system.

A set of four signals are listed in Table 1 that were used in the simulation. The set consists of one pulsed signal of interest (SOI) and up to three interfering signals (IS). The table lists the signal type, carrier frequency, azimuth angle, and polarization for each signal. The SOI is always a 1.0 microsecond pulsed signal at a baseband frequency of 0 MHz. The interfering signals are composed of both narrow band Gaussian noise (NBGN) and wide band Gaussian noise (WBGN) signals with bandwidths of 10 MHz and 20 MHz respectively. Signals are generally distributed in angle, frequency, and polarization, but note that signals 1 and 2 are at the same azimuth angle. A local oscillator frequency of 800 MHz is assumed, which shifts all carrier frequencies down by 800 MHz to a baseband frequency. The baseband frequency is shown in the following plots. The noise level is set 30 dB below the pulsed SOI and all interfering signals are set to a level 20 dB above that of the pulsed SOI.

TABLE 1
Test signals used for simulation

| | | | | Carrier | | | | | |
|---|---|---|---|---|---|---|---|---|---|
| ID | Type | Parameter | | Frequency | Azimuth | Polarization | Case 1 | Case 2 | Case 3 |
| 1 | Pulse | 1 | u-sec | 800 MHz | 95 deg | V | X | X | X |
| 2 | NBGN | 10 | MHz | 800 MHz | 95 deg | LHC | X | X | X |
| 3 | WBGN | 20 | MHz | 785 MHz | 45 deg | RHC | | X | X |
| 4 | WBGN | 20 | MHz | 815 MHz | 135 deg | SL | | | X |

A series of three cases were simulated with various combinations of signals as listed in Table 1.

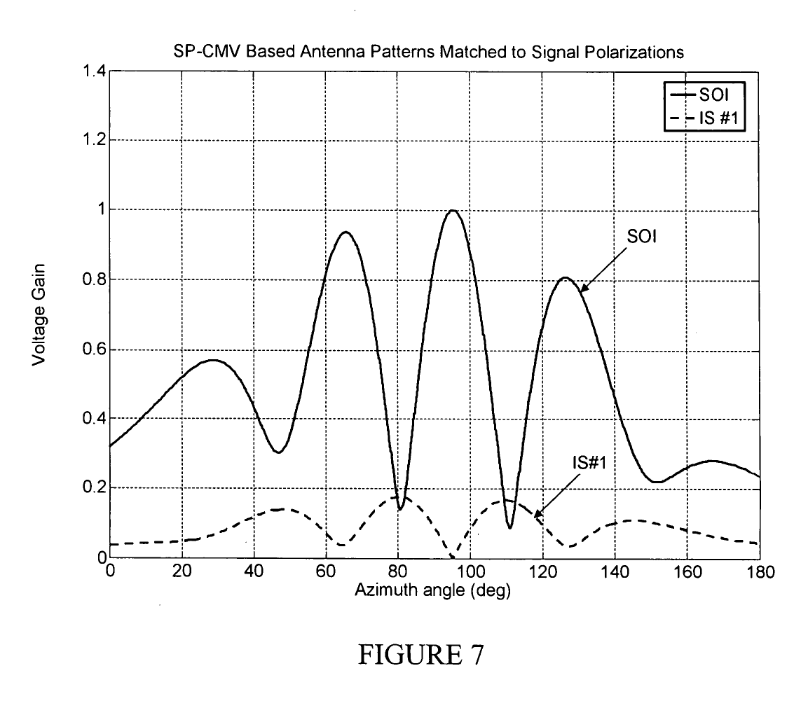

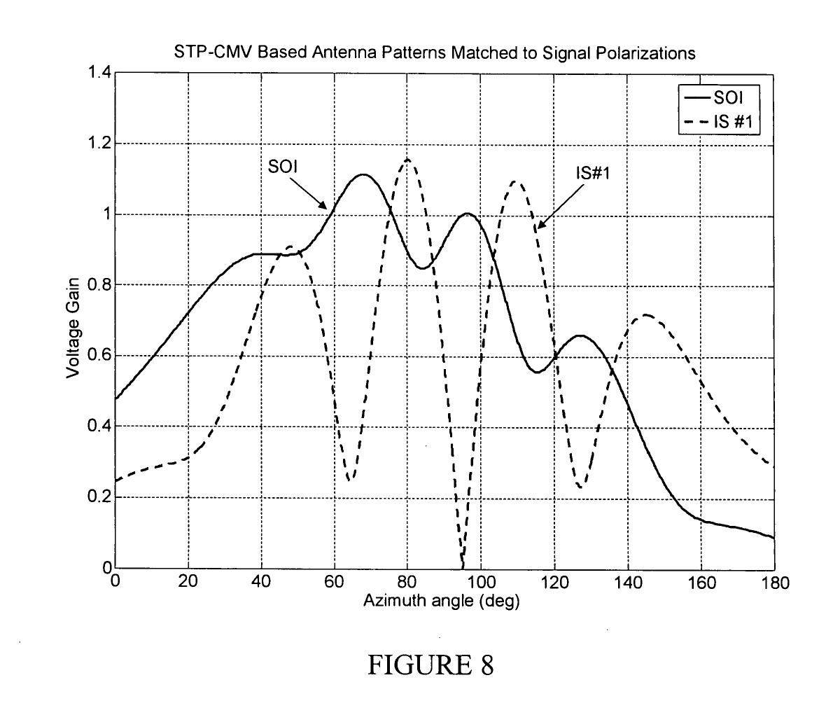

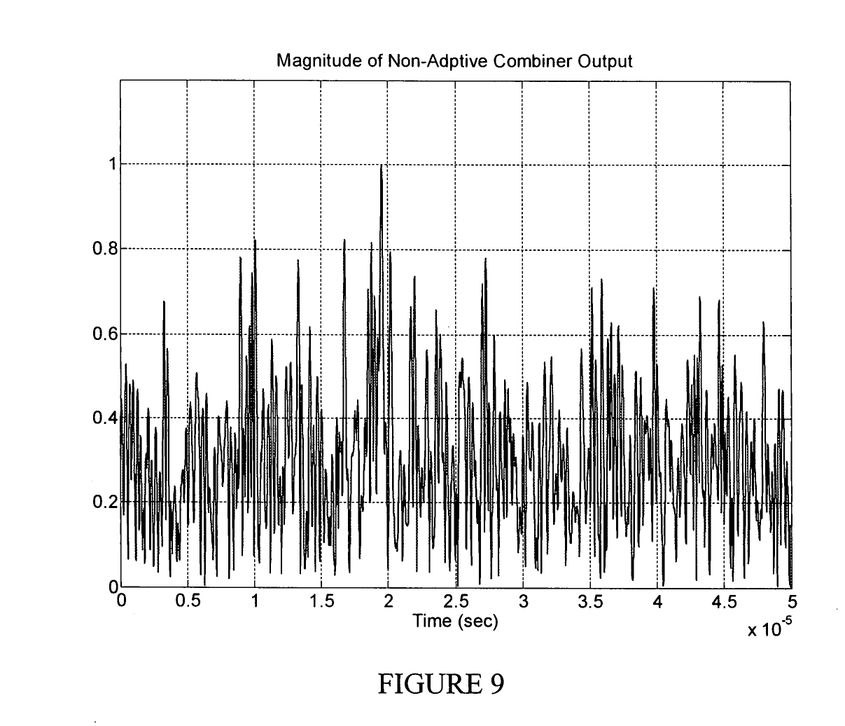

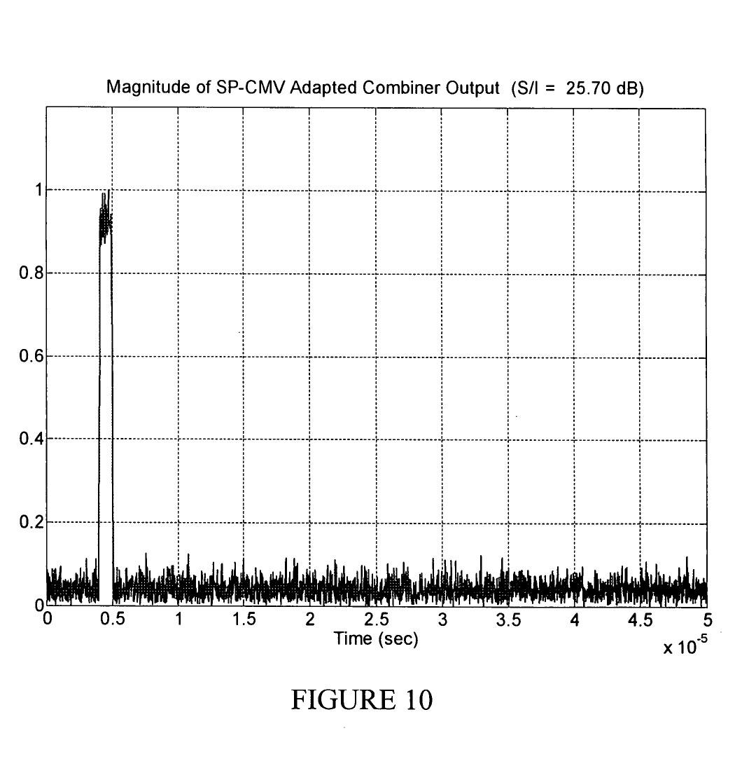

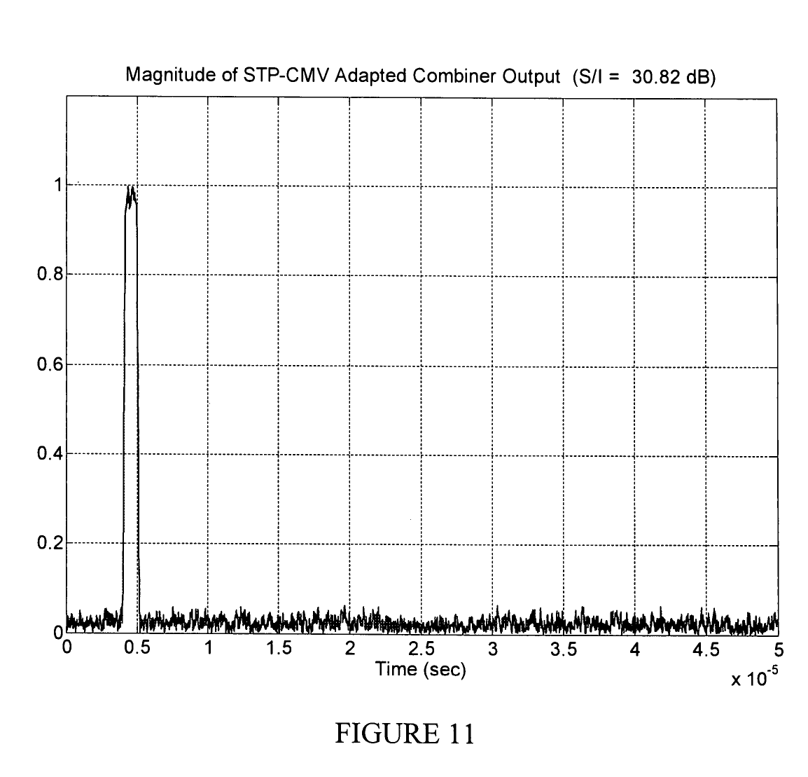

Case 1 involved only two signals, the SOI and one interfering signal at the same angle and frequency, but different polarizations. FIGS. 7 and 8 show the resulting antenna patterns for the SP-CMV and STP-CMV methods for the polarizations corresponding to the two signals. Note that both methods set the antenna gain to unity for the polarization and azimuth of the SOI as required by the constraint. Also, both methods produce nulls at the angle and polarization of the interfering signal. FIG. 9 shows the envelope of the beamformer output without adaptation and FIGS. 10 and 11 show the resulting signal envelope after adaptation for the two methods. Note that the STP-CMV method produces slightly better results.

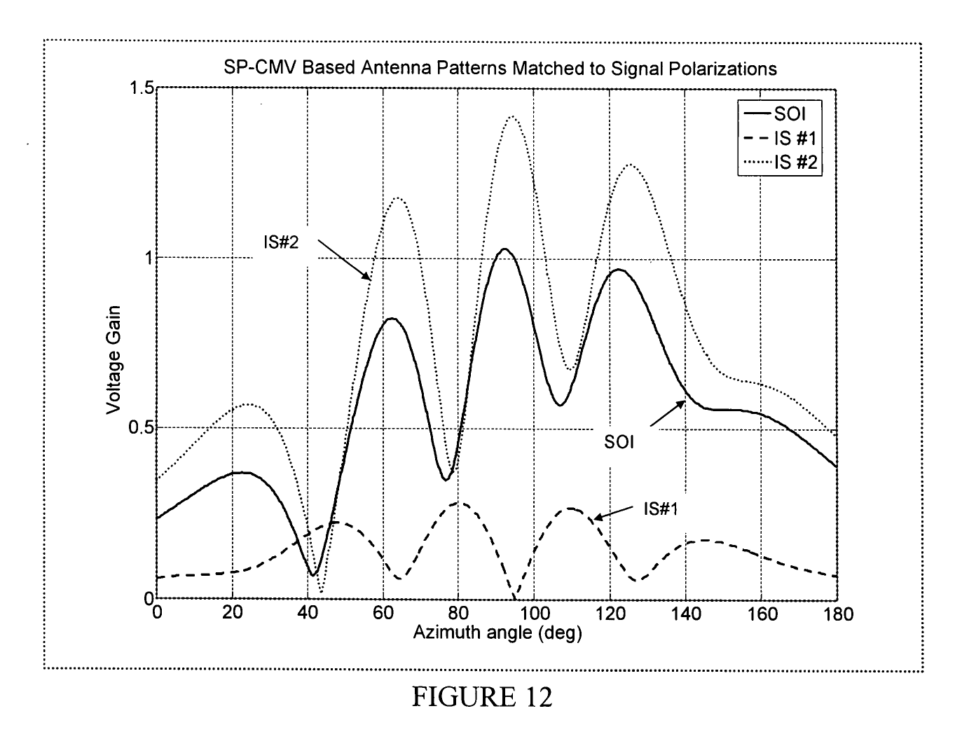

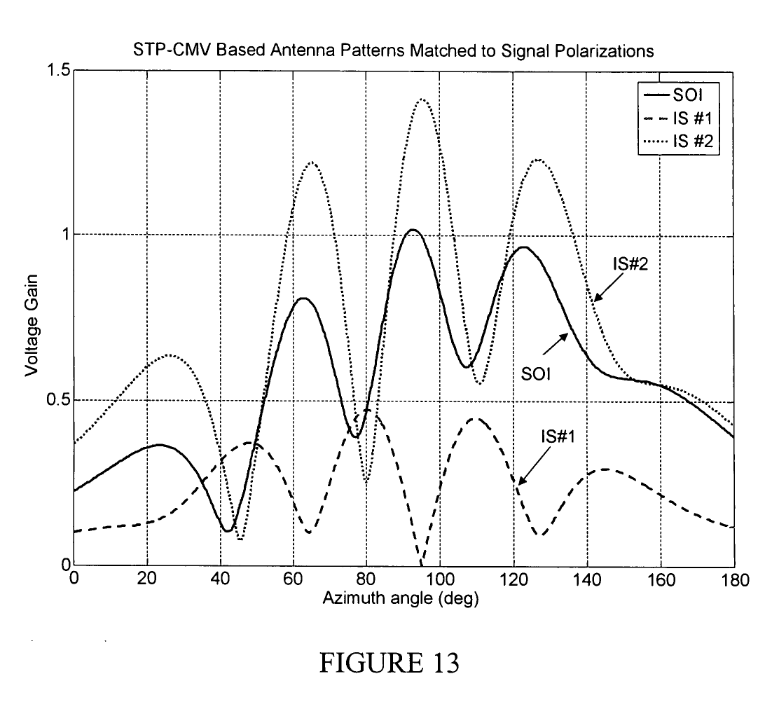

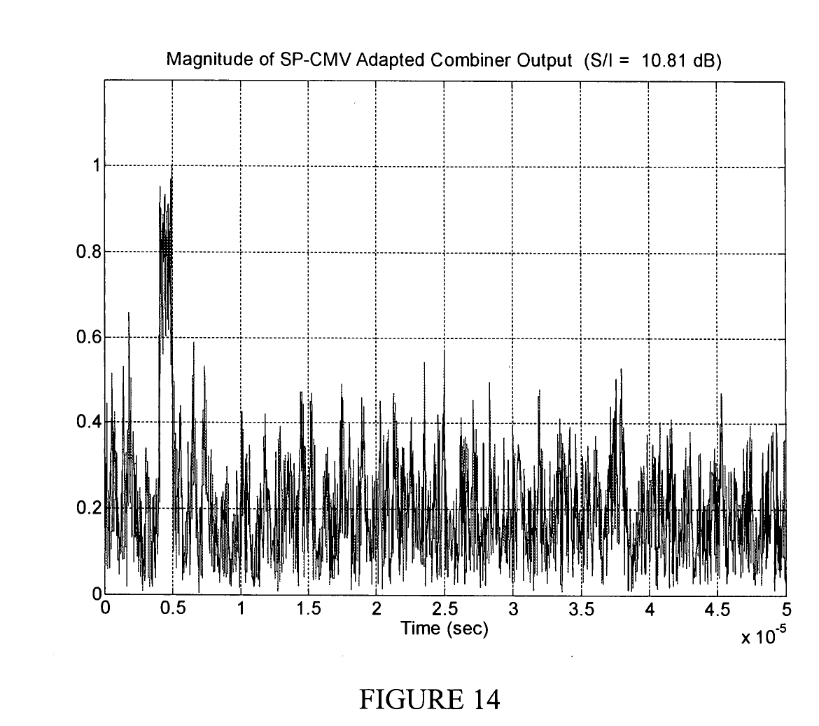

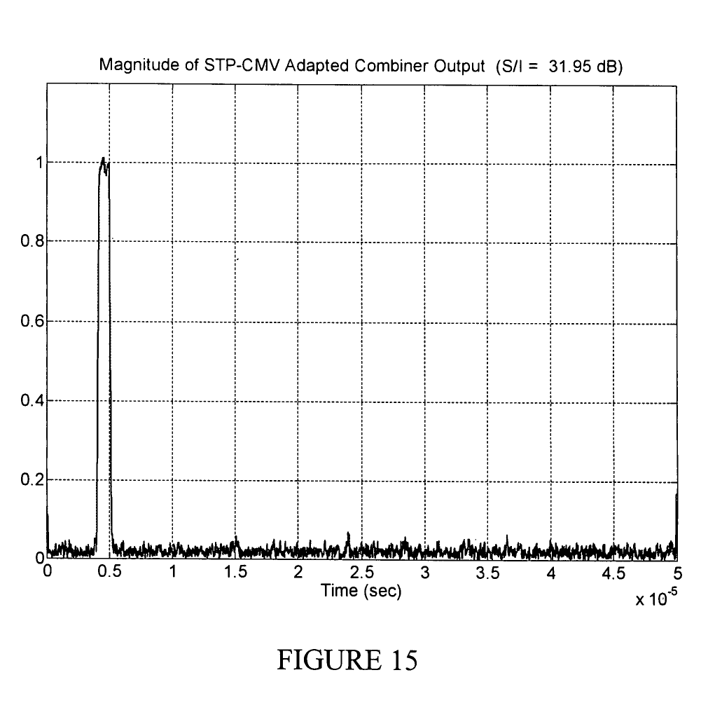

Case 2 adds interfering signal (#3 from Table 1) which is a wideband signal at a lower frequency (785 MHz), different azimuth angle (45 deg) and polarization (RHC). FIGS. 12 and 13 show the adapted pattern using the SP-CMV and STP-CMV methods for this signal set, and FIGS. 14 and 15 show the envelope of the adapted beamformer outputs. Note that while the SP-CMV produces a deeper null than the STP-CMV method at the azimuth of the added signal (i.e. 45 degrees), the envelope of the STP-CMV method shows much more suppression of the total interference. This demonstrates the improved capability that the FIR filters bring to the process.

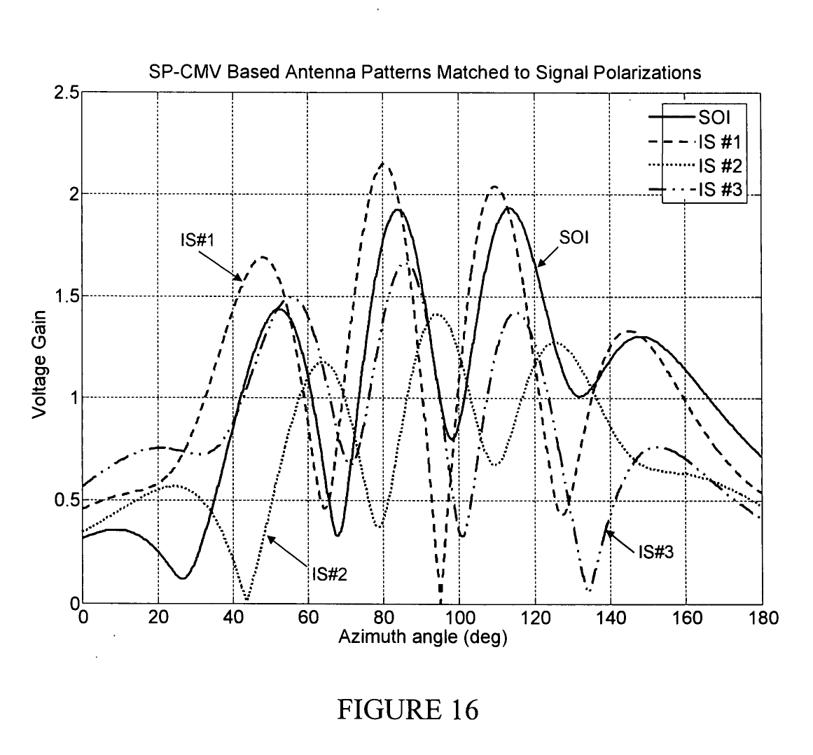

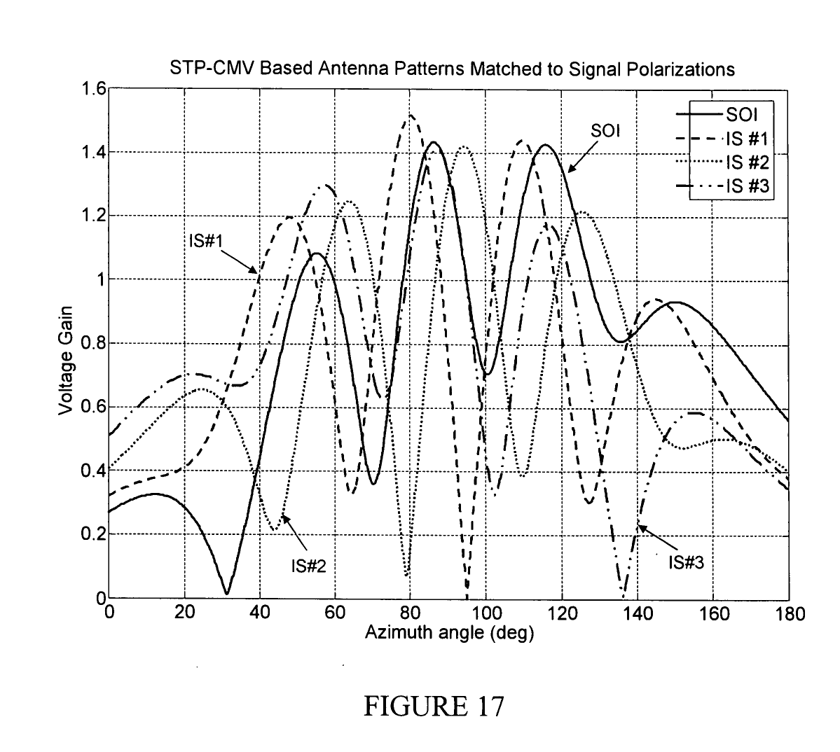

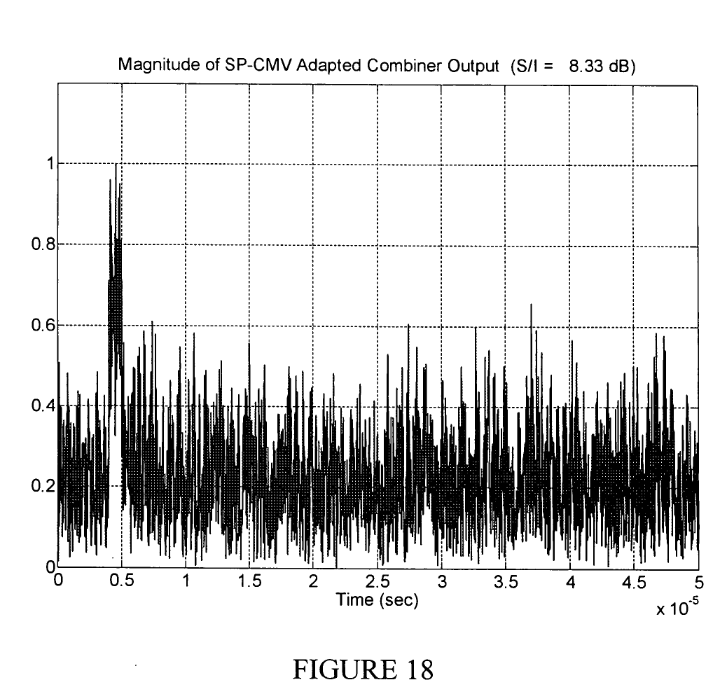

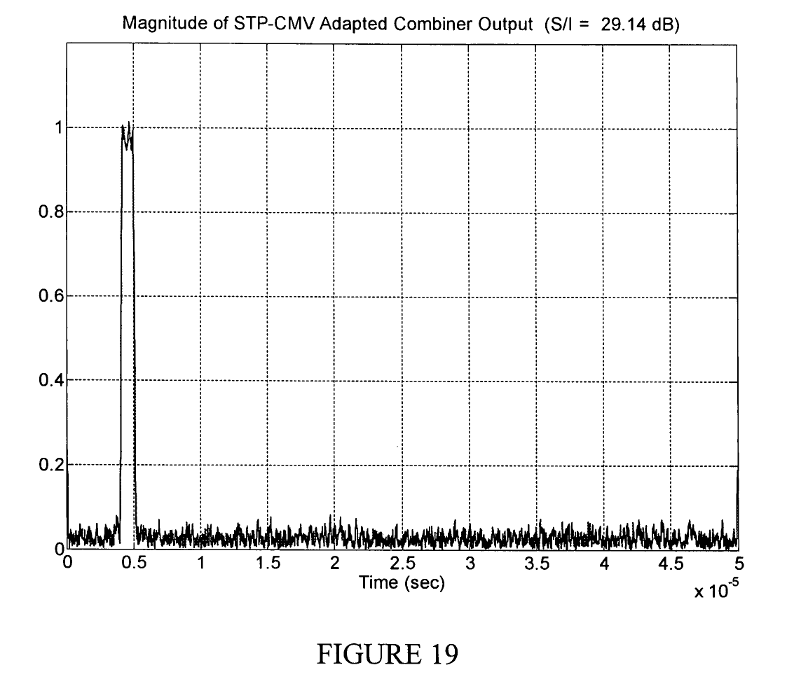

Case 3 adds another interfering signal (#4 from Table 1) to the signal environment. This signal is also a WBGN signal with a carrier frequency of 815 MHz, azimuth angle of 135 degrees and a slant left polarization. FIGS. 16 and 17 show the adapted antenna patterns for this signal set using the SP-CMV and STP-CMV methods, and FIGS. 18 and 19 show the resulting envelopes for the two techniques. Again, note the formation of a null at 135 degrees corresponding to the azimuth of the added signal. Also note that the envelope corresponding to the SP-CMV method is much degraded, indicating that it has reached its limit, while the envelope corresponding to the STP-CMV method still shows a signal-to-interference ratio (SIR) of nearly 30 dB.

Although the present invention has been shown and described in detail with reference to certain exemplary embodiments, the breadth and scope of the present invention should not be limited by the above-described exemplary embodiments, but should be defined only in accordance with the following claims and their equivalents. All variations and modifications that come within the spirit of the invention are desired to be protected.

I claim:

1. An adaptive array for detecting a signal of interest in the presence of an interfering signal, the adaptive array comprising:
a plurality of antenna elements, each antenna element providing an antenna output signal;
a plurality of digital filters having programmable filter weights, each of the plurality of digital filters processing the antenna output signal from one of the plurality of antenna elements and producing a filtered element signal;
a digital beamformer having programmable array weights, the digital beamformer combining the plurality of filtered element signals and producing an adaptive array output signal; and
an adaptive control unit adjusting the filter weights and the array weights to maximize the response of the adaptive array to the signal of interest while minimizing the response of the adaptive array to the interfering signal.

2. The adaptive array of claim 1, wherein the plurality of antenna elements have diverse locations.

3. The adaptive array of claim 1, wherein the plurality of antenna elements have diverse polarizations.

4. The adaptive array of claim 1, wherein at least one of the plurality of antenna elements is a multi-ported element having multiple polarizations.

5. The adaptive array of claim 1, wherein the plurality of digital filters are Finite Impulse Response (FIR) filters.

6. The adaptive array of claim 1, wherein at least one of the frequency, look angle or polarization of the signal of interest is known, and the adaptive control unit uses the at least one known value in adjusting the filter weights and the array weights.

7. The adaptive array of claim 1, wherein the adaptive control unit uses a Constrained Minimum Variance (CMV) control technique to adjust the filter weights and the array weights.

8. The adaptive array of claim 1, wherein the look angle and the polarization of the signal of interest is known, and the adaptive control unit constrains the spatial gain and the polarization response of the adaptive array in the direction of the signal of interest.

9. The adaptive array of claim 8, wherein the frequency of the signal of interest is known, and the adaptive control unit constrains the filter weights to form a pass band at the frequency of the signal of interest.

10. The adaptive array of claim 9, wherein the plurality of antenna elements have diverse locations, and the adaptive control unit constrains the filter weights to equalize the net frequency response of the beamformer to compensate for the dispersion introduced by the diverse locations of the plurality of antenna elements.

11. The adaptive array of claim 7, wherein a frequency of the signal of interest is known and the plurality of antenna elements have diverse locations, and the adaptive control unit constrains the filter weights to equalize the net frequency response of the beamformer to compensate for the dispersion introduced by the diverse locations of the plurality of antenna elements.

12. The adaptive array of claim 1, wherein the look angle and the frequency of the signal of interest is known, and the adaptive control unit constrains the spatial gain in the direction of the signal of interest and constrains the filter weights to form a pass band at the frequency of the signal of interest.

13. The adaptive array of claim 12, wherein the plurality of antenna elements have diverse locations, and the adaptive control unit constrains the filter weights to equalize the net frequency response of the beamformer to compensate for the dispersion introduced by the diverse locations of the plurality of antenna elements.

14. The adaptive array of claim 1, wherein the look angle, the polarization and the frequency of the signal of interest is known, and the adaptive control unit constrains the polarization response of the adaptive array in the direction of the signal of interest and constrains the filter weights to form a pass band at the frequency of the signal of interest.

15. The adaptive array of claim 14, wherein the plurality of antenna elements have diverse locations, and the adaptive control unit constrains the filter weights to equalize the net frequency response of the beamformer to compensate for the dispersion introduced by the diverse locations of the plurality of antenna elements.

16. The adaptive array of claim 1, wherein the frequency of the signal of interest is known and the plurality of antenna elements have diverse locations, and the adaptive control unit constrains the filter weights to form a pass band at the frequency of the signal of interest and to equalize the net frequency response of the beamformer to compensate for the dispersion introduced by the diverse locations of the plurality of antenna elements.

17. A method of processing signals of an adaptive antenna array to receive a signal of interest while suppressing in-band interference signals, the method comprising:
receiving an antenna output signal from each of a plurality of antenna elements;
processing each of the antenna output signals using an adaptive Finite Impulse Response (FIR) filter having programmable FIR filter weights, the finite impulse response filter being configured to reject the interference signals while passing the signal of interest;
combining the outputs of the finite impulse response filters using a spatial beamformer filter having programmable array weights to produce an adaptive array output signal;
constraining the frequency response of the adaptive array at the frequency of the signal of interest using the programmable FIR filter weights and the adaptive array weights;
constraining the spatial gain of the adaptive array in the direction of the signal of interest using the programmable FIR filter weights and the programmable array weights;
constraining the polarization of the adaptive array in the direction of the signal of interest to the polarization of the signal of interest using the programmable FIR filter weights and the programmable array weights; and
minimizing the mean square value of the adaptive array output signal subject to the constraints on frequency response, spatial gain, and polarization of the adaptive array.

18. The method of claim 17, wherein the minimizing and constraining steps comprise:
inputting the antenna output signals from the plurality of antenna elements and the adaptive array output signal into an adaptive control unit;
processing the signals in the adaptive control unit to produce the programmable FIR filter weights and the programmable array weights.

19. The method of claim 18, wherein the processing step comprises:
forming a Constrained Minimum Variance cost function that minimizes average output power of the adaptive array output signal subject to gain requirements at the frequency of the signal of interest, gain requirements in the direction of the signal of interest and polarization requirements at the direction and polarization of the signal of interest.

20. The method of claim 17, further comprising:
constraining the frequency response of the adaptive array to equalize the net frequency response of the beamformer to compensate for the dispersion introduced by the spatial distribution of the plurality of antenna elements.
